(19) United States
(12) Patent Application Publication
(10) Pub. No.: US 2006/0044283 A1
(43) Pub. Date: Mar. 2, 2006

(54) Information processing apparatus and display control program

(76) Inventors: Michiaki Eri, Hino-shi (JP); Shinichi Kashimoto, Ome-shi (JP); Hiroyuki Nemoto, Nishitokyo-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/086,927

(22) Filed: Mar. 22, 2005

(30) Foreign Application Priority Data
Aug. 31, 2004 (JP) 2004-252439

(51) Int. Cl. G09G 5/00

(52) U.S. Cl. 345/173

(57) ABSTRACT

An information processing apparatus comprising a display unit which displays, on a display screen, a first display area displaying a first buttons and a second display area displaying a second buttons, a sensing unit which senses a touched position on the display screen, and a first display control unit which, when the first display area is touched, enlarging the size of each of the first buttons, expanding the size of the first display area such that the first buttons are arranged in the first display area, reducing the size of the second display area, and reducing the size of each of at least specific buttons of the second buttons such that the specific buttons are arranged in the reduced second display area.

### CROSS-REFERENCE TO RELATED APPLICATION

This application is based upon and claims the benefit of priority from the prior Japanese Patent Application No. 2004-252439, filed Aug. 31, 2004, the entire contents of which are incorporated herein by reference.

### BACKGROUND OF THE INVENTION

1. Field of the Invention

The present invention relates to an information processing apparatus capable of sensing a position touched on a display screen by a user, and a display control program used in the apparatus.

2. Description of the Related Art

Generally, window systems capable of displaying a plurality of overlapped window objects on a display screen are used in computers.

As one of these window systems, Japanese Patent Application KOKAI Publication No. 2003-195994 discloses an apparatus having a function of managing the display priority order of a plurality of objects for each group. In this apparatus, when a certain window object is selected, window objects which belong to the same group as the selected window object are displayed in front of window objects of other groups.

Recently, portable information processing apparatuses such as PDAs (Personal Digital Assistants) are begging to be widely used.

Many PDAs have a touch panel display portion, so a position touched on the display screen by a user's finger or a pen can be sensed. An application program displays a plurality of buttons on the display screen. When a certain button on the display screen is touched by a user's finger or a pen, a function corresponding to the touched button is executed. Therefore, the user can use the application program only by an intuitive operation of touching the button.

Unfortunately, the display screen sizes of PDAs are generally much smaller than those of ordinary personal computers. This limits the number of buttons simultaneously displayable on the display screen of a PDA.

Accordingly, in an application program which may require a large number of buttons to be displayed, these buttons must be selectively displayed for each group. In this case, while a certain button group is displayed, no other button groups are displayed. Therefore, all buttons prepared for the application program cannot be simultaneously presented to the user. The user operates the application program while changing button groups to be displayed. This largely degrades the operable of the PDA.

Also, if the size of each button is decreased so that all button groups can be simultaneously displayed on the display screen, the user finds difficulty in touching these buttons. Especially when the user is trying to touch a button with his or her finger, an operation error may occur, e.g., buttons other than the button of interest may be touched together.

### SUMMARY OF THE INVENTION

It is an object of an embodiment of the invention to provide an information processing apparatus and program capable of simultaneously displaying a plurality of button groups, and capable of displaying each button by a size readily touchable by the user.

According to an embodiment of the invention, there is provided an information processing apparatus comprising a display unit which displays, on a display screen, a first display area comprising a plurality of first buttons and a second display area comprising a plurality of second buttons, sensing means for sensing a touched position on the display screen, first display control means for, when the first display area is touched, enlarging a size of each of the plurality of first buttons, and expanding a size of the first display area such that the enlarged first buttons are arranged in the first display area, reducing a size of the second display area, and reducing a size of each of at least specific buttons of the reduced second buttons such that the specific buttons are arranged in the reduced second display area.

In an embodiment, an information processing apparatus comprises a display unit which displays, on a display screen, a first display area displaying first buttons and a second display area displaying second buttons, a sensor which senses a touched position on the display screen, and first display control means for, when the first display area is touched, enlarging a size of the first buttons, expanding a size of the first display area such that the enlarged first buttons are arranged in the first display area, reducing a size of the second display area, and reducing a size of at least specific buttons of the second buttons such that the specific buttons are arranged in the reduced second display area.

In another embodiment, a method of displaying information comprises displaying, on a display screen, a first display area displaying first buttons and a second display area displaying second buttons, sensing a touched position on the display screen, and enlarging a size of the first buttons when the first display area is touched. The method further comprises expanding a size of the first display area such that the enlarged first buttons are arranged in the first display area, reducing a size of the second display area, and reducing a size of at least specific buttons of the second buttons such that the specific buttons are arranged in the reduced second display area.

In a further embodiment, an information processing apparatus comprises a display unit which displays, on a display screen, a first display area displaying first buttons and a second display area displaying second buttons, and a sensor which senses a touched position on the display screen, where when the touched position on the display screen is in the first display area, a size of the first buttons enlarges and a size of the first display area expands such that the enlarged first buttons are arranged in the first display area, and a size of the second display area reduces and a size of at least specific buttons of the second buttons reduces such that the specific buttons are arranged in the reduced second display area.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

The accompanying drawings, which are incorporated in and constitute a part of the specification, illustrate presently preferred embodiments of the invention and, together with the general description given above and the detailed description of the preferred embodiments given below, serve to explain the principles of an embodiment of the invention.

FIG. 1 is a view showing the outer appearance of an information processing apparatus according to an embodiment of the invention;

FIG. 2 is a block diagram showing the system configuration of the information processing apparatus of the same embodiment;

FIG. 3 is a block diagram showing the functional configuration of an IP phone application program used by the information processing apparatus of the same embodiment;

FIG. 4 is a view showing an example of an operation window displayed by the IP phone application program shown in FIG. 3;

FIG. 5 is a view showing the state in which a first button group in the operation window shown in FIG. 4 is touched by a user;

FIG. 6 is a view showing example of the state in which the first button group in the operation window shown in FIG. 4 is displayed in an enlarged scale in response to the touch operation in FIG. 5;

FIG. 7 is a view showing the state in which indicators in the operation window shown in FIG. 6 are turned on;

FIG. 8 is a view showing the state in which a second button group in the operation window shown in FIG. 6 is touched by the user;

FIG. 9 is a view showing example of the state in which the second button group in the operation window shown in FIG. 6 is displayed in an enlarged scale in response to the touch operation in FIG. 8;

FIG. 10 is a view for explaining the state transition of each button group managed by the IP phone application program shown in FIG. 3;

FIG. 11 is a flowchart showing the sequence of a property changing process executed by the IP phone application program shown in FIG. 3;

FIG. 12 is a flowchart showing the sequence of a display control process executed by the IP phone application program shown in FIG. 3; and

FIG. 13 is a view showing another example of the operation window displayed by the IP phone application program shown in FIG. 3.

### DETAILED DESCRIPTION OF THE PREFERRED EMBODIMENT

An embodiment of the invention will be described below with reference to the accompanying drawing.

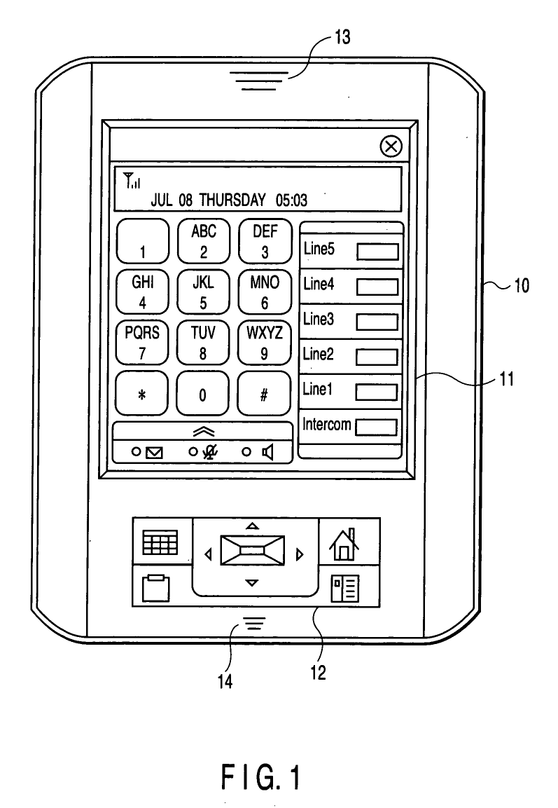

FIG. 1 shows the outer appearance of an information processing apparatus according to the embodiment of the invention. This information processing apparatus is a portable information processing apparatus, and implemented as, e.g., a PDA (Personal Digital Assistant).

A PDA 10 is an information processing apparatus which supports pen input, and so designed as to be able to sense a position touched on the display screen by a pen (stylus) or a user's finger. The PDA 10 has a thin boxy housing. On the upper surface of this housing, a display unit 11 and operation keys 12 are arranged. The display unit 11 has a tablet for sensing positions touched on the display screen by a user. The operation keys 12 form an input unit for inputting various data. The operation keys 12 include push button switches for selecting and determining a target function from a menu displayed on the display unit 11, and push button switches for activating various application programs.

An IP (Internet Protocol) phone application program is installed in the PDA 10. This IP phone application program has a function of executing communication such as voice conversation with another terminal by using the VoIP (Voice over Internet Protocol) technique. A speaker 13 is placed in the upper portion of the upper surface of the housing of the PDA 10, and a microphone 14 is placed in the lower portion of the upper surface of the housing. A user can use the PDA 10 as a cell phone by using this IP phone application program.

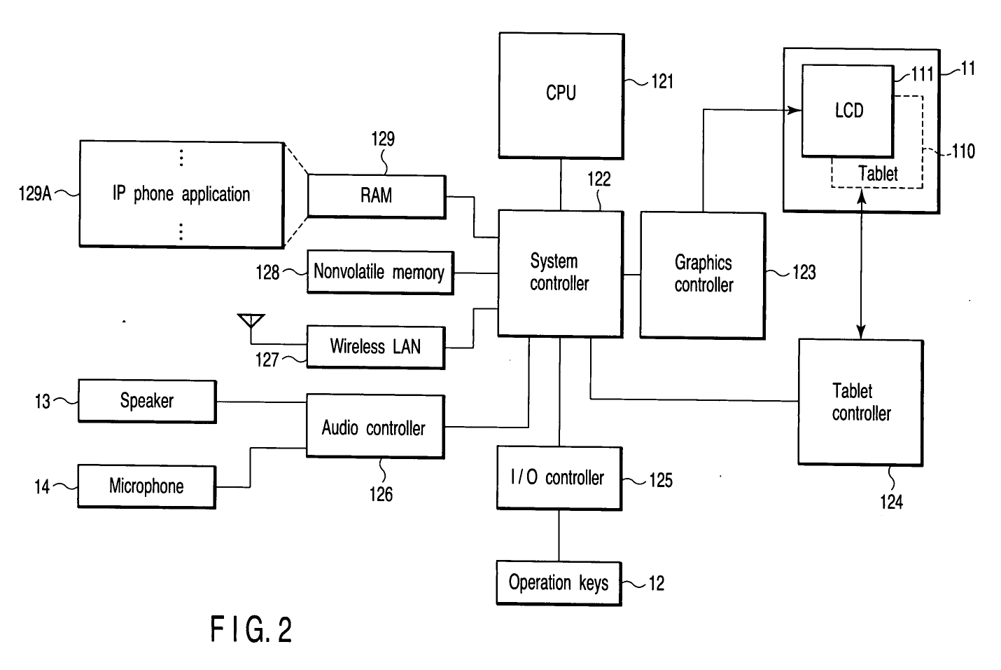

FIG. 2 is a block diagram showing the system configuration of the PDA 10. The PDA 10 includes a CPU 121, system controller 122, graphics controller 123, tablet controller 124, I/O controller 125, audio controller 126, wireless LAN 127, nonvolatile memory 128, RAM 129, and the like, in addition to the display unit 11, operation keys 12, speaker 13, and microphone 14 described above.

The display 11 is made up of a tablet 110 and liquid crystal display (LCD) 111. The tablet 110 is, e.g., a coordinate sensor placed on the display screen of the LCD 111. As described above, the tablet 110 can sense a position (touch position) touched on the display screen by a user's finger or a pen. By this function of the tablet 110, the display screen of the LCD 111 functions as a so-called touch screen.

The CPU 121 is a processor for controlling the operation of the PDA 10, and controls each component of the PDA 10 via the system controller 122. The CPU 121 executes an operating system and various application programs including an IP phone application program 129A loaded from the nonvolatile memory 128 into the RAM 129. The RAM 129 functions as a main memory of the PDA 10. The operating system supports the pen input function. Coordinate information indicating a position touched on the display screen of the LCD 111 by the user can be acquired via the tablet controller 124.

The system controller 122 incorporates a memory controller which controls access to the nonvolatile memory 128 and RAM 129. The system controller 122 also has a function of communicating with the graphics controller 123.

The graphics controller 123 is a display controller which controls the LCD 111 used as a display monitor of the PDA 10. The tablet controller 124 controls the tablet 110, and acquires, from the tablet 110, coordinate data indicating a position touched on the display screen of the LCD 111 by the user.

The I/O controller 125 controls the operation keys 12, and inputs even/data corresponding to a pressed push button switch of the operation keys 12. The audio controller 126 executes a process of outputting a sound corresponding to voice data to be played back from the speaker 13, and a process of loading a user's voice input from the microphone 14 as voice data. The wireless LAN 127 is a wireless communication device which executes wireless communication with an external apparatus. The IP phone function is executed by connecting the PDA 10 to an office LAN or to an external network such as the Internet by the wireless LAN 127.

The IP phone application program 129A is activated when a predetermined push button switch, to which activation of the IP phone application program 129A is assigned, of the operation keys 12 is pressed, or when an item corresponding to the IP phone application program 129A is selected from a program menu displayed on the display screen. The activated IP phone application program 129A displays, on the LCD 111, an operation window as a GUI (Graphical User Interface) for using the IP phone function via the graphics controller 123. This operation window displays a plurality of buttons as follows.

Numerical buttons: These numerical buttons are used to input a number (telephone number) for designating the communication partner of the IP phone.

Function buttons: These function buttons are used to control additional functions for the IP phone and various functions pertaining to voice input/output.

The IP phone application program 129A has a function of dividing a plurality of buttons comprising the numerical buttons and function buttons displayed in the operation window into several button groups, and managing an attribute (to be referred to as a property hereinafter) corresponding to each button group. Each button group is displayed in a display area which is defined in the operation window and corresponds to the button group. That is, the operation window includes a plurality of display areas in one-to-one correspondence with a plurality of button groups.

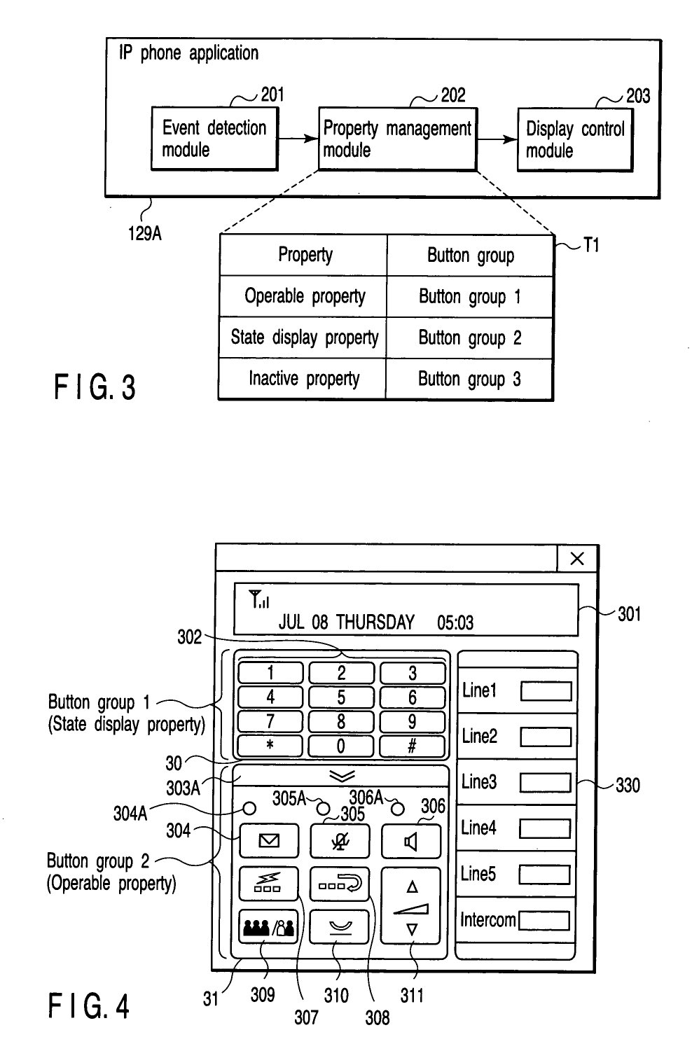

The functional configuration of the IP phone application program 129A will be explained below with reference to FIG. 3.

As shown in FIG. 3, the IP phone application program 129A includes an event detection module 201, property management module 202, and display control module 203.

The event detection module 201 detects the occurrence of a touch event indicating that a button or display area in the operation window is touched by a user's finger or a pen. The property management module 202 manages property management information indicative of a property assigned to each button group by using a property management table T1. In this embodiment, the following three types of properties are defined.

Operable property: An operable property indicates that the operation and status display function of each button which belongs to a button group assigned the operable property is displayed in the operation window by a relatively large size (first size) readily touchable by a user's finger. When a certain button in a button group, which is assigned the operable property is touched by a user's finger or a pen, a function corresponding to the button is executed.

State display property: A state display property indicates that the operation of each button which belongs to a button group assigned this state display property is invalid, but a status display function of each button which belongs to this button group, such as, a function indicative of an incoming telephone call or the like is valid. For space saving, each button which belongs to a button group assigned the state display property is displayed in the operation window by a small size visible to a user, i.e., by a second size smaller than the first size. Even when a certain button in a button group assigned the state display property is touched by a user's finger or a pen, a function corresponding to the button is basically not executed. Note that it is not always necessary to display all buttons which belong to a button group assigned the state display property, i.e., it is also possible to display some representative buttons which belong to the button group.

Inactive property: An inactive property indicates that both the operation and status display function of each button, which belongs to a button group assigned this inactive property are invalid. Each button which belongs to a button group assigned the inactive property is displayed in the operation window by a small size visible to a user, i.e., by the second size smaller than the first size. Even when a certain button in a button group assigned the inactive property is touched by a user's finger or a pen, a function corresponding to the button is not executed.

Note that a certain button group has no status display function. When the state display property is assigned to this button group, the button group is set in the same state as a button group assigned the inactive property.

When an arbitrary position in a display area corresponding to a button group assigned the state display property or inactive property is touched by the user, the property management module 202 automatically switches the properties of this button group and a button group currently assigned the operable property. That is, the property management module 202 changes the property management information of the property management table T1, changes the property of the touched button group from the state display property or inactive property to the operable property, and also changes the property of the button group assigned the operable property from the operable property to the state display property or inactive property.

On the basis of the property management information of the property management table T1, the display control module 203 displays, in the operation window, each button group in a state corresponding to the property assigned to the button group.

FIG. 4 shows an example of the operation window displayed on the display screen of the LCD 111 by the IP phone application program 1 29A.

This operation window includes a first display area 30 for displaying button group 1, and a second display area 31 for displaying button group 2.

Button group 1 is made up of numerical buttons 302. Button group 1 functions as a GUI (Graphical User Interface) for inputting the telephone number of the communication partner. Some of the numerical buttons 302 are assigned a function of inputting symbols such as alphabets.

Button group 2 is made up of function buttons 302. Button group 2 functions as a GUI (Graphical User Interface) for controlling the IP phone function. As shown in FIG. 4, button group 2 includes an answering machine button 304, answering machine status indicator 304A, microphone mute button 305, microphone mute status indicator 305A, speaker ON button 306, speaker status indicator 306A, speed dial button 307, redial button 308, conference communication button 309, hold button 310, and volume control button 311.

The answering machine button 304 plays back an answering machine message such as a saved voice message. A voice message (voice mail) from a calling party is automatically saved in the nonvolatile memory 128 of the PDA 10. When a voice message is recorded in the nonvolatile memory 128, the answering machine status indicator 304A flickers to notify the user that the answering machine message is present.

The microphone mute button 305 sets valid/invalid of the microphone 14. The microphone mute status indicator 305A notifies the user whether the microphone 14 is set valid or invalid. The speaker ON button 306 executes a normal off-hook/on-hook function. The speaker status indicator 306A generates a ringing tone and flickers when an incoming call from the communication partner is received, thereby notifying the user that he or she is called.

The speed dial button 307 executes a function of calling a telephone number corresponding to a person registered by, e.g., the user. The redial button 308 executes a redial function. The conference communication button 309 executes a function which allows conversation between a plurality of persons. The hold button 310 executes a holding function. The volume control button 311 controls the volume of the output sound from the speaker 13.

In addition, an operation window display area 301 and telephone line switching display area 330 are also arranged in the operation window.

The operation window display area 301 displays the present day/time, the radio wave state, a dial number input by the user, and the like. The telephone line switching display area 330 displays a plurality of telephone line switching buttons for switching telephone lines (extension/outside line).

Assume that the state display property is assigned to button group 1 displayed in the first display area 30, and the operable property is assigned to button group 2 displayed in the second display area 31.

In this state, each of the buttons 304 to 311 which belong to button group 2 is displayed by the first size operable by a user's finger. On the other hand, each of the buttons 302 which belong to button group 1 is displayed by the second size smaller than the first size.

A reduce button 303A is also displayed in the second display area 31 corresponding to button group 2 assigned the operable property. The reduce button 303A executes a function of changing the property of a button group, to which the reduce button 303A is related, from the operable property to the state display property/inactive property.

An operation of changing the properties of button group 1 and button group 2 will be explained below.

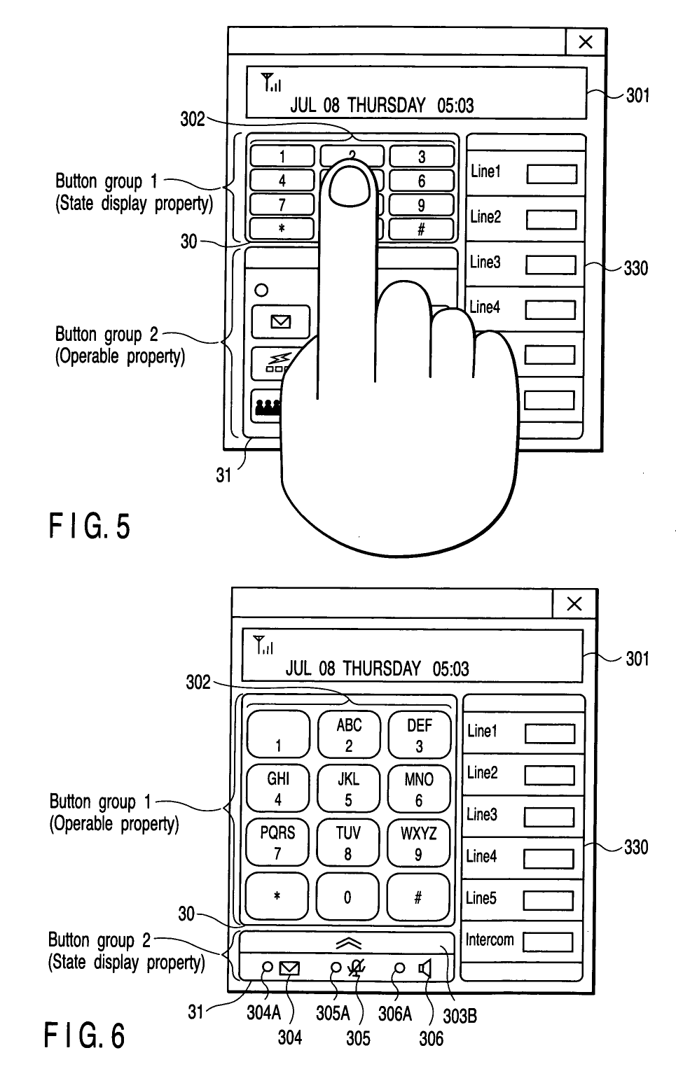

Assume, as shown in FIG. 5, that a position on the display screen, which corresponds to an arbitrary position in the first display area 30 corresponding to button group 1 is touched by the user. Since the property assigned to button group 1 is the state display property, the size of each button of button group 1 displayed in the first display area 30 is small. In this state, therefore, it is difficult for the user to accurately touch an intended button of button group 1 with his or her finger. In this embodiment, when any position in the first display area 30 corresponding to button group 1 is touched by the user, a process of changing the operation window from the window shown in FIG. 4 to a window shown in FIG. 6 is automatically executed.

That is, when a position on the display screen, which corresponds to an arbitrary position in the first display area 30 corresponding to button group 1 is touched by the user, the property management module 202 changes the properties of button group 1 and button group 2. More specifically, the property management module 202 changes the property of button group 1 from the state display property to the operable property, and changes the property of button group 2 from the operable property to the state display property.

In response to this property changing, the display control module 203 enlarges the size of each of the buttons 302 which belong to button group 1, and expands the size of the first display area 30 so that the enlarged buttons 302 are arranged in the first display area 30. In this manner, the buttons which belong to button group 1 are displayed by a large size readily touchable by a user's finger.

In addition, the display control module 203 reduces the size of the second display area 31 so that the enlarged first display area 30 does not overlap the second display area 31, and reduces the size of specific buttons (e.g., the answering machine button 304, microphone mute button 305, and speaker ON button 306) of the buttons 302 in button group 2 and the size of the indicators 304A, 305A, and 306A so that these specific buttons and indicators are arranged in the reduced second display area 31.

Also, the display control module 203 displays an enlarge button 303B, instead of the reduce button 303A described above, in the second display area 31 corresponding to button group 2 assigned the state display property. The enlarge button 303B executes a function of changing the property of a button group corresponding to the enlarge button 303B from the state display property/inactive property to the operable property.

As described above, when button group 1 assigned the state display property is touched, the property of touched button group 1 is changed from the state display property to the operable property, and each button in touched button group 1 is displayed in an enlarged scale. Accordingly, the user can automatically make a button group, to which a button to be operated belongs, operable by a finger, by touching the vicinity of this button to be operated.

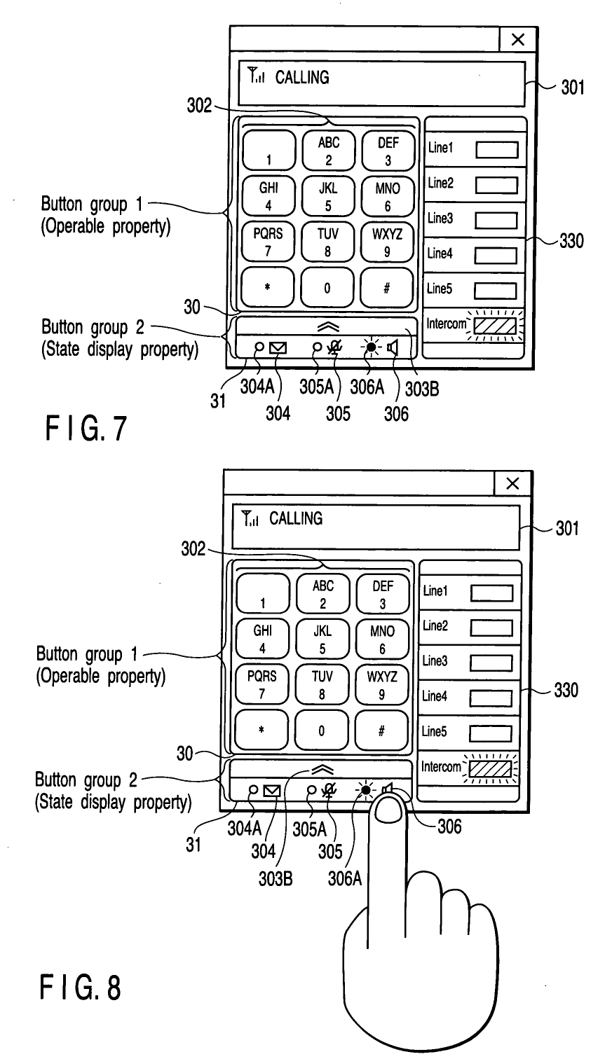

The operation of the IP phone application program 129A when a telephone call is received from the partner while the PDA 10 is in the state shown in FIG. 6 will be described below with reference to FIGS. 7 to 9.

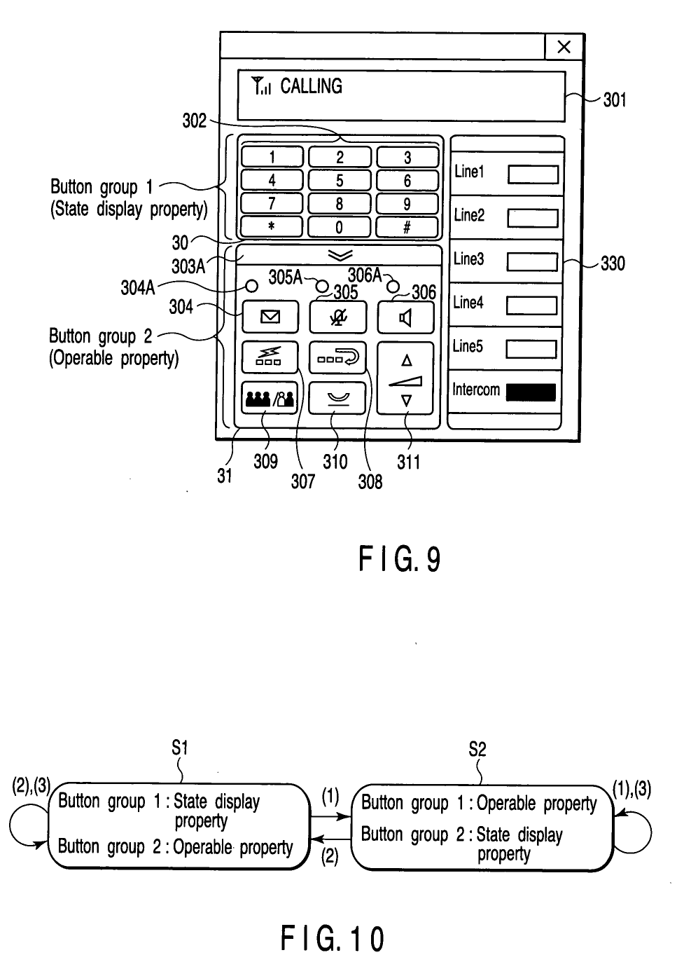

FIG. 7 is a view showing the state in which a telephone call is received from the partner while the PDA 10 is in the state shown in FIG. 6. When an incoming call is received from an outside line, for example, an outside line button (intercom) flickers, and the speaker status indicator 306A also flickers. When the user touches the vicinity of the speaker ON button 306 as shown in FIG. 8 in order to perform an off-hook operation, a process of changing the operation window from a window shown in FIG. 8 to a window shown in FIG. 9 is automatically executed.

That is, when a position on the display screen, which corresponds to an arbitrary position in the second display area 31 corresponding to button group 2 is touched by the user, the property management module 202 changes the properties of button group 1 and button group 2. More specifically, the property management module 202 changes the property of button group 2 from the state display property to the operable property, and changes the property of button group 1 from the operable property to the state display property.

In response to this property changing, the display control module 203 enlarges the sizes of the buttons and indicators which belong to button group 2, and expands the size of the second display area 31 so that the enlarged buttons and indicators are arranged in the second display area 31. In this manner, the buttons which belong to button group 2 are displayed by a large size readily touchable by a user's finger.

In addition, the display control module 203 reduces the size of the first display area 30 so that the enlarged second display area 31 does not overlap the first display area 30, and reduces the sizes of the buttons 302 in button group 1 so that the buttons 302 are arranged in the reduced first display area 30.

Also, the display control module 203 displays the reduce button 303A described above in the second display area 31 corresponding to button group 2 assigned the operable property.

As described above, when button group 2 assigned the state display property is touched, the property of touched button group 2 is changed from the state display property to the operable property, and each button in touched button group 2 is displayed in an enlarged scale.

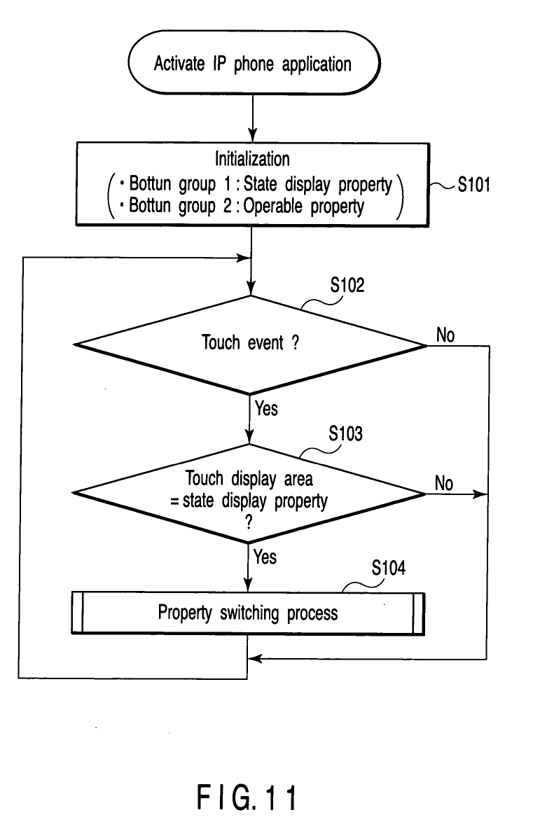

The state transitions of button groups 1 and 2 will be explained below with reference to FIG. 10.

In state S1, the property corresponding to button group 1 is the state display property, and the property corresponding to button group 2 is the operable property. In state S2, the property corresponding to button group 1 is the operable property, and the property corresponding to button group 2 is the state display property.

Assume that the present state is state S1. If event (1) in which the display area 30 corresponding to button group 1 assigned the state display property is touched occurs, the present state changes from state S1 to state S2. In state S1, since the operation each button of button group 1 are invalidated, no operation errors occur even if a plurality of buttons or a button other than the button of interest is touched in event (1).

In state S2, if event (2) in which the display area 31 corresponding to button group 2 assigned the state display property is touched occurs, the present state changes from state S2 to state S1. In state S2, since the operation each button of button group 2 are invalidated, no operation errors occur even if a plurality of buttons or a button other than the button of interest is touched in event (2).

Also, if event (2) in which the display area 31 corresponding to button group 2 assigned the operable property is touched occurs when the present state is state S1, a function corresponding to the button touched in event (2) is executed. State S1 is not changed to state S2, but maintained as the present state. State S1 is also maintained even if event (3) in which a portion other than the display areas 30 and 31 is touched.

If event (1) in which the display area 30 corresponding to button group 1 assigned the operable property is touched occurs when the present state is state S2, a function corresponding to the button touched in event (1) is executed. State S2 is not changed to state S1, but maintained as the present state. State S2 is also maintained even if event (3) in which a portion other than the display areas 30 and 31 is touched.

A practical sequence of the property changing process executed by the IP phone application program 129A will be described below with reference to a flowchart shown in FIG. 11.

The IP phone application program 129A executed by the CPU 121 executes the following processing by looking up the property management table T1 stored in the nonvolatile memory 128.

When the IP phone application program 129A is activated, the property management module 202 of the IP phone application program 129A initializes the property management information of the property management table T1, and assigns the state display property to button group 1 and the operable property to button group 2 (step S101). As a consequence, the display control module 203 of the IP phone application program 129A displays the operation window shown in FIG. 4 on the display screen of the LCD 111.

The event detection module 201 of the IP phone application program 129A cooperates with the operating system to discriminate the presence/absence of the occurrence of an event (touch event) in which the display screen of the LCD 111 is touched by a user's finger or a pen (step S102). If a touch event occurs (YES in step S102), the event detection module 201 checks whether the touched position on the display screen corresponds to the display area of a button group presently assigned the state display property (step S103). If the touched position on the display area corresponds to the display area of a button group presently assigned the state display property, i.e., if the display area of a button group presently assigned the state display property is touched (YES in step S103), the property management module 202 changes the property management information of the property management table T1, and executes the property changing process (step S104). In this property changing process, the property management module 202 changes the current properties of button groups 1 and 2.

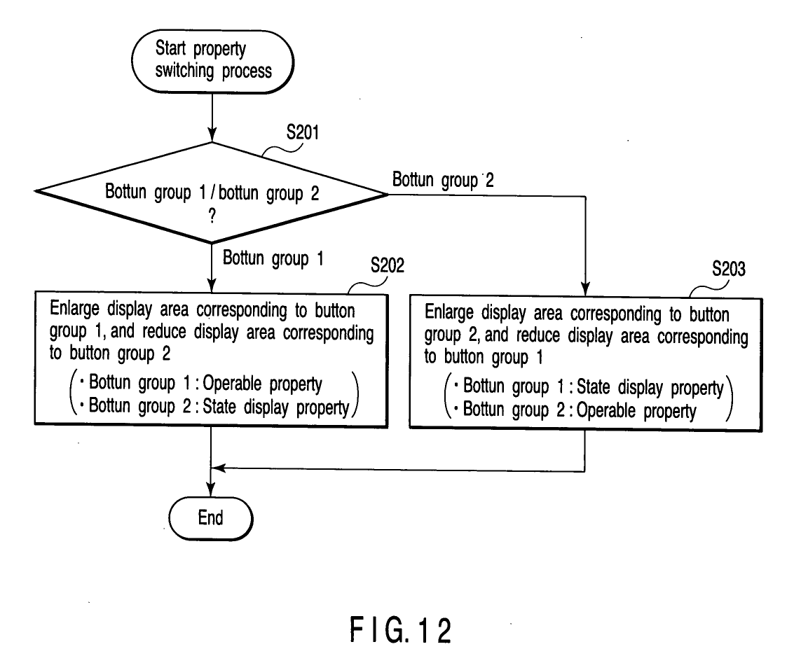

A practical sequence of the display control process executed in the property changing process will be explained below with reference to a flowchart shown in FIG. 12.

When the property management information of the property management table T1 is changed, the display control module 203 refers to the property management information, and checks whether a button group newly assigned the operable property is button group 1 or button group 2 (step S201).

If this button group is button group 1, the display control module 203 enlarges the size of each button which belongs to button group 1 and the size of the display area 30 corresponding to button group 1, and reduces the size of each button which belongs to button group 2 and the size of the display area 31 corresponding to button group 2 (step S202). In this manner, the operation window shown in FIG. 6 is displayed on the display screen of the LCD 111.

If the button group is button group 2, the display control module 203 enlarges the size of each button which belongs to button group 2 and the size of the display area 31 corresponding to button group 2, and reduces the size of each button which belongs to button group 1 and the size of the display area 30 corresponding to button group 1 (step S203). In this way, the operation window shown in FIG. 4 is displayed on the display screen of the LCD 111.

In an embodiment as described above, the operable property is assigned to one of button groups 1 and 2 simultaneously displayed in one operation window, and the state display property/inactive property is assigned to the other. Each button which belongs to a button group assigned the operable property is displayed by a relatively large size easily touchable by a user's finger. Each button which belongs to a button group assigned the state display property/inactive property is displayed by a visible small size. When an arbitrary position in the display area corresponding to the button group assigned the state display property/inactive property is touched, the properties of button groups 1 and 2 are changed. Therefore, the buttons for operating the IP phone application program 129A can be simultaneously displayed in the operation window, and buttons corresponding to functions which the user wants to use can be displayed by a size readily touchable by the user.

In an embodiment, the operation window shown in FIG. 4 is used as a default operation window. However, the main purpose of an ordinary IP phone application program is to initiate a call to the communication partner by dialing the dial buttons. Therefore, the operation window shown in FIG. 6 may also be used as a default operation window.

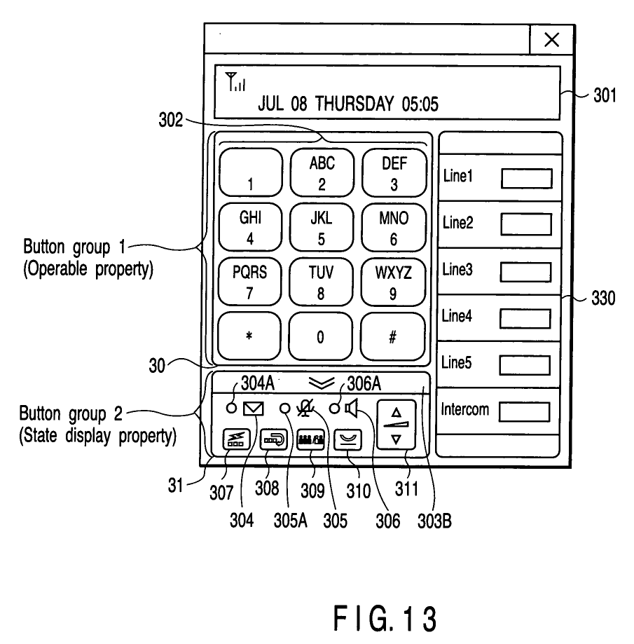

Also, as shown in FIG. 13, the buttons of button group 2 assigned the state display property can be displayed in the display area 31. This allows the user to readily recognize, in the same display window, the buttons which this IP phone application program can have and the present set of conditions.

In addition, as shown in FIG. 5, when a position on the display screen, which corresponds to a button of, e.g., number “5” of the buttons 302 in the first display area 30 corresponding to button group 1 is touched by the user, number “5” may also be input at the same time the first display area 30 is displayed in an expanded scale. That is, in an embodiment, even when the current property of button group 1 is the state display property, the button functions of button group 1 can be validated. In this case, the user may press a button other than the button of interest by mistake because the size of each button in the display area 30 is small. However, the input numeral or the like can be deleted by inputting a function button having a delete function of the operation keys 12. Likewise, in an embodiment, even when the current property of button group 2 is the state display property, the button functions of button group 2 can be validated. This allows the user to immediately perform an off-hook operation by touching the speaker ON button 306 displayed in a reduced scale.

The property changing process described above is applicable not only to the IP phone application program 129A, but also to any arbitrary application program which displays a large number of buttons.

Also, the sequence of this property changing process is implemented by a computer program. Therefore, the same effects as this embodiment can be easily realized by installing this computer program in an ordinary computer via a computer-readable storage medium. Furthermore, in another embodiment, the enlarge button (303B in FIG. 8) and reduce button (303A in FIG. 9) may also be omitted.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display unit which displays, on a display screen, a first display area displaying first buttons and a second display area displaying second buttons;
a sensor which senses a touched position on the display screen; and
first display control means for, when the first display area is touched, enlarging a size of the first buttons, expanding a size of the first display area such that the enlarged first buttons are arranged in the first display area, reducing a size of the second display area, and reducing a size of at least specific buttons of the second buttons such that the specific buttons are arranged in the reduced second display area.

2. The apparatus of claim 1, further comprising means for, when one of the enlarged first buttons is touched, executing a function assigned to the touched button.

3. The apparatus of claim 1, further comprising a wireless communication unit which executes wireless communication with an external apparatus, and wherein
the first buttons include numerical buttons which are used to input a number for designating a communication partner, and
the second buttons include function buttons which are used to control a function pertaining to the wireless communication.

4. The apparatus of claim 3, further comprising means for displaying, in the reduced second display area, an indicator indicating a present status of the wireless communication.

5. The apparatus of claim 1, further comprising:
second display control means for, when the second display area is touched, enlarging the size of each of the second buttons, and expanding the size of the second display area such that the enlarged second buttons are arranged in the second display area; and
third display control means for, when the size of the second display area is enlarged, reducing the size of the first display area, and reducing the size of each of the first buttons to arrange the first buttons in the first display area.

6. The apparatus of claim 1 further comprising:
means for storing attribute management information for designating one of first and second button groups to be displayed on the display screen as an operable button group;
means for, based on the attribute management information, displaying each button included in the one of the first and second button groups by a first size in a first display area on the display screen, and displaying each button included in other of the first and second button groups by a second size smaller than the first size in a second display area on the display screen; and
means for, when the second display area is touched, changing the attribute management information, and changing a button group designated as the operable button group from the one of the first and second button groups to the other.

7. The apparatus of claim 6, further comprising means for, when one button of a button group designated as the operable button group is touched, executing a function assigned to the touched button.

8. A method of displaying information comprising:
displaying, on a display screen, a first display area displaying first buttons and a second display area displaying second buttons;
sensing a touched position on the display screen;
enlarging a size of the first buttons when the first display area is touched;
expanding a size of the first display area such that the enlarged first buttons are arranged in the first display area;
reducing a size of the second display area; and
reducing a size of at least specific buttons of the second buttons such that the specific buttons are arranged in the reduced second display area.

9. The method of claim 8, further comprising executing a function assigned to the touched button when one of the enlarged first buttons is touched.

10. The method of claim 8, further comprising executing wireless communication with an external apparatus, and wherein
the first buttons include numerical buttons which are used to input a number for designating a communication partner, and
the second buttons include function buttons which are used to control a function pertaining to the wireless communication.

11. The method of claim 10, further comprising displaying, in the reduced second display area, an indicator indicating a present status of the wireless communication.

12. The method of claim 8, further comprising:
when the second display area is touched, enlarging the size of each of the second buttons, and expanding the size of the second display area such that the enlarged second buttons are arranged in the second display area; and
when the size of the second display area is enlarged, reducing the size of the first display area, and reducing the size of each of the first buttons to arrange the first buttons in the first display area.

13. The method of claim 8 further comprising:
storing attribute management information for designating one of first and second button groups to be displayed on the display screen as an operable button group;
based on the attribute management information, displaying each button included in the one of the first and second button groups designated as the operable button group by a first size in a first display area on the display screen;
based on the attribute management information, displaying each button included in other of the first and second button groups by a second size smaller than the first size in a second display area on the display screen;
when the second display area is touched, changing the attribute management information; and
changing a button group designated as the operable button group from the one of the first and second button groups to the other.

14. The method of claim 13, further comprising, when one button of a button group designated as the operable button group is touched, executing a function assigned to the touched button.

15. The method of claim 11 wherein the method is implemented as computer readable program code.

16. An information processing apparatus comprising:
a display unit which displays, on a display screen, a first display area displaying first buttons and a second display area displaying second buttons; and
a sensor which senses a touched position on the display screen;
wherein when the touched position on the display screen is in the first display area, a size of the first buttons enlarges and a size of the first display area expands such that the enlarged first buttons are arranged in the first display area, and a size of the second display area reduces and a size of at least specific buttons of the second buttons reduces such that the specific buttons are arranged in the reduced second display area.

17. The apparatus of claim 16, wherein, when one of the enlarged first buttons is touched, a function assigned to the touched button is executed.

18. The apparatus of claim 16, further comprising a wireless communication unit which executes wireless communication with an external apparatus, and wherein
the first buttons include numerical buttons which are used to input a number for designating a communication partner, and
the second buttons include function buttons which are used to control a function pertaining to the wireless communication.

19. The apparatus of claim 18, further comprising an indicator indicating a present status of the wireless communication displayed in the reduced second display area.

20. The apparatus of claim 16, wherein, when the touched position on the display screen is in the second display area, the size of each of the second buttons enlarges and the size of the second display area expands such that the enlarged second buttons are arranged in the second display area, and the size of the first display area reduces, and the size of each of the first buttons reduces such that the reduced first buttons are arranged in the first display area.
